(19) United States
(12) Patent Application Publication
(10) Pub. No.: US 2024/0368011 A1
(43) Pub. Date: Nov. 7, 2024

(54) DEVICES AND SYSTEMS HAVING A REMOVABLE CARTRIDGE FOR PREPARING A CHEMICAL SOLUTION FOR WATER TREATMENT

(71) Applicant: INNOVATIVE WATER CARE, LLC, Alpharetta, GA (US)

(72) Inventors: Touraj Rowhani, Alpharetta, GA (US); David W. Blanchette, Milford, CT (US); Stephane Gautier, Atlanta, GA (US)

(73) Assignee: INNOVATIVE WATER CARE, LLC, Alpharetta, GA (US)

(21) Appl. No.: 18/645,461

(22) Filed: Apr. 25, 2024

Related U.S. Application Data
(60) Provisional application No. 63/499,502, filed on May 2, 2023.

(51) Int. Cl. C02F 1/68; C02F 103/34; C02F 103/42

(52) U.S. Cl. CPC C02F 1/688; C02F 2103/34; C02F 2103/42; C02F 2201/005; C02F 2201/006

(57) ABSTRACT

Devices and systems are provided for preparing a chemical solution. The device includes a housing having a chamber, an opening to allow an aqueous fluid to flow into the chamber, and an outlet to allow a chemical solution to flow out of the chamber, and a removable cartridge configured to retain a solid chemical material and to be received within the chamber. The removable cartridge has an opening to receive the aqueous fluid and an opening to allow the chemical solution to flow out of the cartridge. The device is configured to direct flow of the aqueous fluid into the chamber to contact surfaces of the solid chemical material within the cartridge, dissolve the solid chemical material, and create the chemical solution of the aqueous fluid and the chemical material dissolved therein.

### CROSS REFERENCE TO RELATED APPLICATIONS

This application claims the benefit of U.S. Provisional Application No. 63/499,502, filed May 2, 2023, which is hereby incorporated by reference herein in its entirety.

### TECHNICAL FIELD

The present invention generally relates to water treatment, and more particularly relates to devices and systems having a removable cartridge for preparing a chemical solution for water treatment.

### BACKGROUND

Water is used in many commercial, industrial, and recreational applications. Depending on the specific end use, water may require specific treatments. The end use may include, but is not limited to, drinking, industrial water supply, irrigation, river flow maintenance, water recreation, or many other uses, including the safe return of used water to the environment. Water treatment generally improves the quality of the water by removing contaminants and undesirable components or reducing their concentration so that the water becomes fit for its desired end use. When left untreated, water may cause corrosion or mechanical failure of equipment to occur, resulting in costly repairs. Furthermore, in certain applications, if left untreated, water may provide for growth of bacteria, algae, and other undesirable organisms, such that persons exposed to an untreated water supply, either by way of ingestion or direct physical contact, may become ill and face serious medical issues, and possibly death.

Common water treatment practices generally rely on the introduction of treatment chemicals to control such organisms on a periodic or continuous basis. For example, some water treatment systems use chemical feeders that bring water into contact with solid, dry treatment chemicals. The feeders are designed to dissolve the treatment chemicals in the water in a controlled manner. In conventional chemical feeders, solid pellets of calcium hypochlorite (“cal hypo”) are dissolved to introduce chlorine into the water stream. Chlorine in the water is generally expressed as a concentration of free available chlorine (FAC). In order to provide dissolution at a desired rate to maintain the desired FAC concentration, conventional chemical feeders often require extensive maintenance. Treatment chemicals must be added to the device frequently, and maintenance is also required to remove the accumulation of deposits or residue on the device, such as calcium carbonate deposits. As such, conventional chemical feeder designs generally require considerable supervision and intervention (i.e., monitoring equipment and handling of chemical materials) to ensure the chemical feeder is functioning as intended, which can be arduous and time consuming and further result in a user being exposed to chemicals during handling thereof.

Hence, there is a need for devices and/or systems for water treatment that can reduce the supervision and intervention necessary to ensure the chemical feeder is functioning and reduce the likelihood of exposure of the chemical material during handling thereof relative to existing devices and systems.

### BRIEF SUMMARY

This summary is provided to describe select concepts in a simplified form that are further described in the Detailed Description. This summary is not intended to identify key or essential features of the claimed subject matter, nor is it intended to be used as an aid in determining the scope of the claimed subject matter.

A device is provided for preparing a chemical solution. The device includes a housing having a chamber, a chamber opening at a first end thereof configured to allow an aqueous fluid to flow into the chamber, and a chamber outlet at a second end thereof configured to allow a chemical solution to flow out of the chamber, and a removable cartridge configured to retain therein a solid chemical material and to be received and releasably retained within the chamber, the removable cartridge having an opening at a first end thereof configured to receive the aqueous fluid from the chamber opening and at least one opening adjacent a second end thereof configured to allow the chemical solution to flow out of the cartridge toward the chamber outlet. The device is configured to direct flow of the aqueous fluid into the chamber to contact surfaces of the solid chemical material within the cartridge, dissolve the solid chemical material, and create the chemical solution of the aqueous fluid and the chemical material dissolved therein.

A system is provided for preparing a chemical solution. The system includes a chemical feeder having a housing comprising a chamber, a chamber opening at a first end thereof configured to allow an aqueous fluid to flow into the chamber, and a chamber outlet at a second end thereof configured to allow a chemical solution to flow out of the chamber, and a removable cartridge configured to retain therein a solid chemical material and to be received and releasably retained within the chamber, the removable cartridge having an opening at a first end thereof configured to receive the aqueous fluid from the chamber opening and at least one opening adjacent a second end thereof configured to allow the chemical solution to flow out of the cartridge toward the chamber outlet. The chemical feeder is configured to direct flow of the aqueous fluid into the chamber to contact surfaces of the solid chemical material within the cartridge, dissolve the solid chemical material, and create the chemical solution of the aqueous fluid and the chemical material dissolved therein.

A device is provided that includes a housing having a chamber therein, an opening configured to provide access to the chamber, and two or more channels recessed in interior surfaces of the housing adjacent the opening, a housing inlet configured to receive aqueous fluid and direct the aqueous fluid into the chamber, a housing outlet configured to receive the aqueous fluid from the chamber and direct the aqueous fluid therefrom, and a lid assembly configured to releasably cover and seal the opening of the housing, the lid assembly including a first member configured to cover the opening of the housing and a second member rotatably coupled to the first member, wherein the second member includes two or more rolling members configured to be received within the two or more channels of the housing, wherein the second member is configured to be selectively rotated relative to the first member to apply a force on the first member and thereby seal the opening, wherein rotation of the second member causes the two or more rolling members to travel within the two or more channels such that the second member moves toward the first member, wherein the two or more channels include features configured to retain the rolling members in position once the second member is applying the force on the first member.

Furthermore, other desirable features and characteristics of the device and system will become apparent from the subsequent detailed description and the appended claims, taken in conjunction with the accompanying drawings and the preceding background.

### BRIEF DESCRIPTION OF THE DRAWINGS

The present invention will hereinafter be described in conjunction with the following drawing figures, wherein like numerals denote like elements, and wherein:

FIG. 1 shows a perspective view of an embodiment of a water treatment device in accordance with certain aspects of the invention;

FIG. 2 shows a first cross-sectional view of the water treatment device of FIG. 1;

FIG. 3 shows a second cross-sectional view of the water treatment device of FIG. 1;

FIG. 4 shows an isolated, cross-sectional view of a lower portion of the water treatment device of FIG. 1;

FIG. 5 shows an exploded view of a lid assembly of the water treatment device of FIG. 1;

FIG. 6 shows a perspective, cross-sectional view of the lid assembly of FIG. 1;

FIG. 7 shows an exploded view of a top cap of the lid assembly of FIG. 5;

FIG. 8 shows an exploded view of a lock plate of the lid assembly of FIG. 5;

FIG. 9 shows an isolated, exploded view of a rolling member and corresponding shaft of the water treatment device of FIG. 1;

FIG. 10 shows various views of an upper flange of the water treatment device of FIG. 1; and

FIG. 11 shows a perspective view of the cartridge of the water treatment device of FIG. 1.

### DETAILED DESCRIPTION

The following detailed description is merely exemplary in nature and is not intended to limit the invention or the application and uses of the invention. As used herein, the word “exemplary” means “serving as an example, instance, or illustration.” Thus, any embodiment described herein as “exemplary” is not necessarily to be construed as preferred or advantageous over other embodiments. All of the embodiments described herein are exemplary embodiments provided to enable persons skilled in the art to make or use the invention and not to limit the scope of the invention which is defined by the claims. Furthermore, there is no intention to be bound by any expressed or implied theory presented in the preceding technical field, background, brief summary, or the following detailed description.

By way of overview, the present invention is directed to devices and related systems and methods for preparing a chemical solution. The invention is useful for water treatment, as the devices and systems may be used to prepare chemical solutions by mixing a chemical material with an aqueous fluid (e.g., water) and providing the chemical solution to water undergoing treatment. In certain embodiments, the chemical material may be calcium hypochlorite (Ca(OCl)₂), also known as cal hypo. However, it should be noted that any chemical material may be used. Often, the chemical material is provided in solid form as briquettes or tablets. The devices of the present invention dissolve the briquettes or tablets in the aqueous fluid to prepare a chemical solution for water treatment. Accordingly, the devices may be referred to herein as erosion feeders or chemical feeders, for example. The devices of the present invention may be particularly useful for commercial or residential swimming pool chlorination, municipal drinking water chlorination, agricultural water chlorination, and industrial water chlorination.

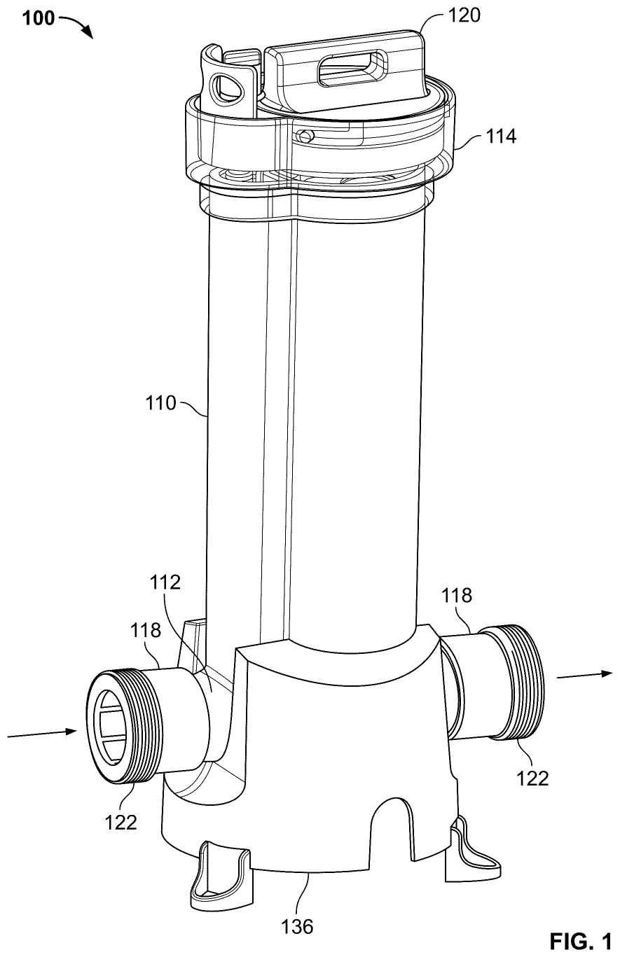

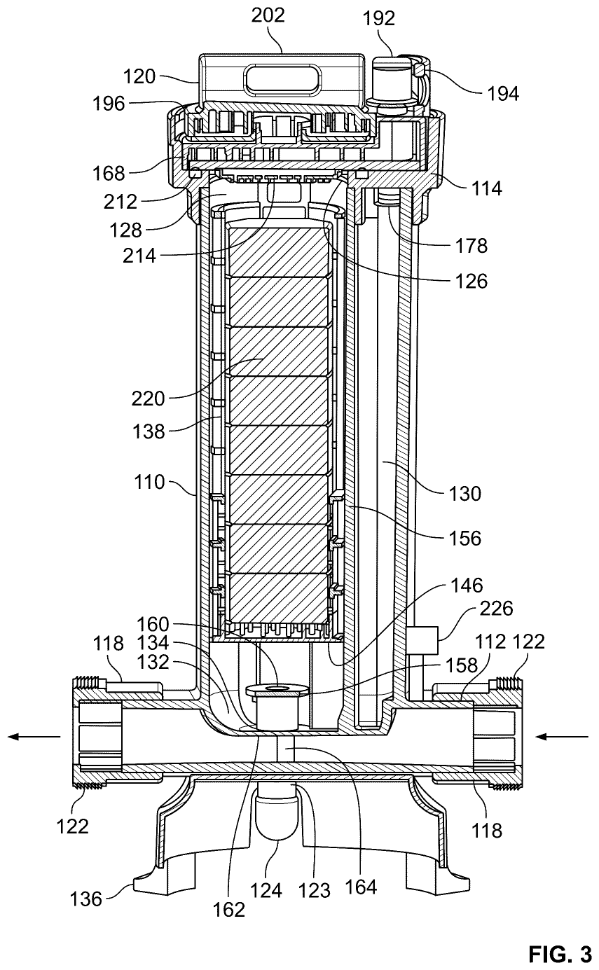

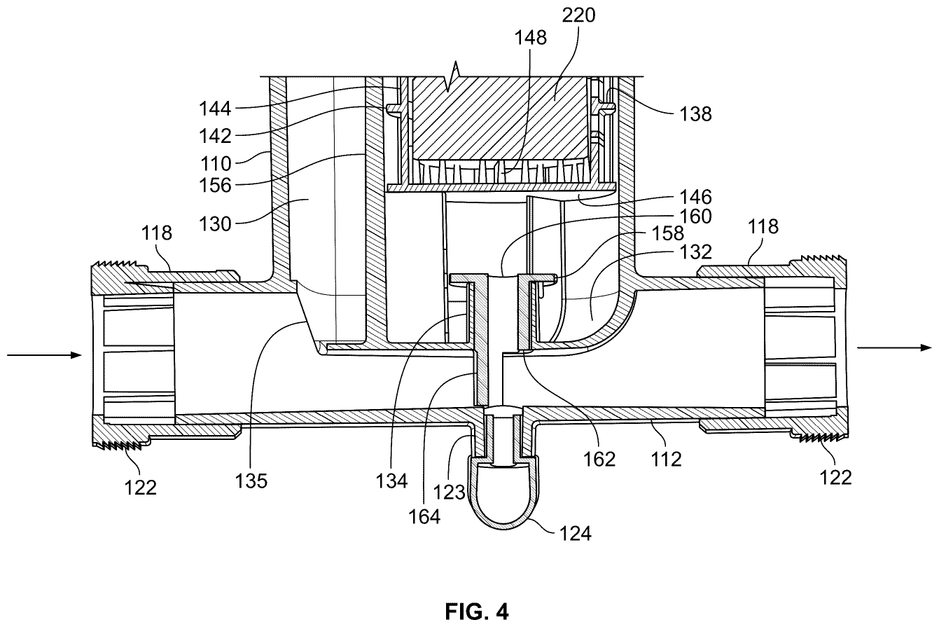

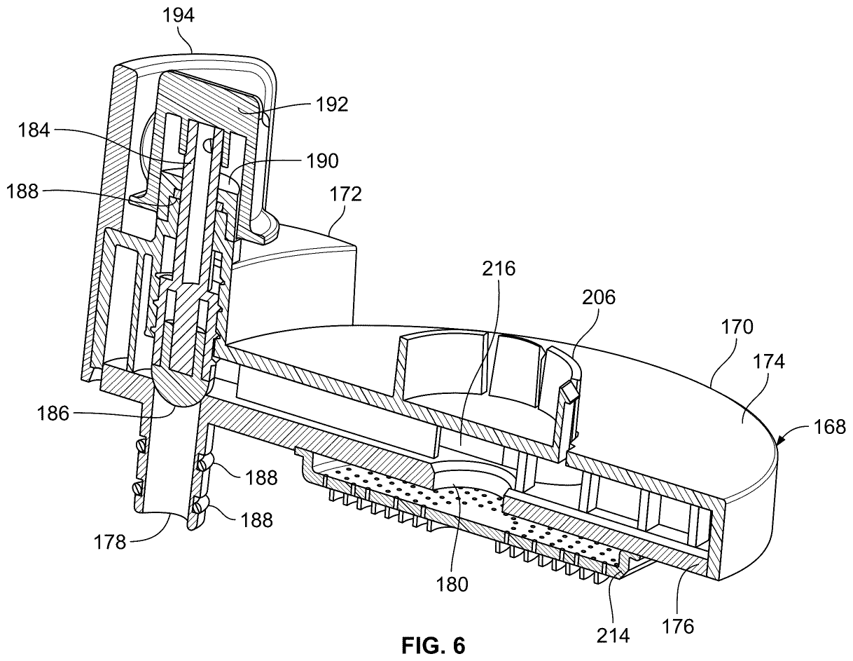

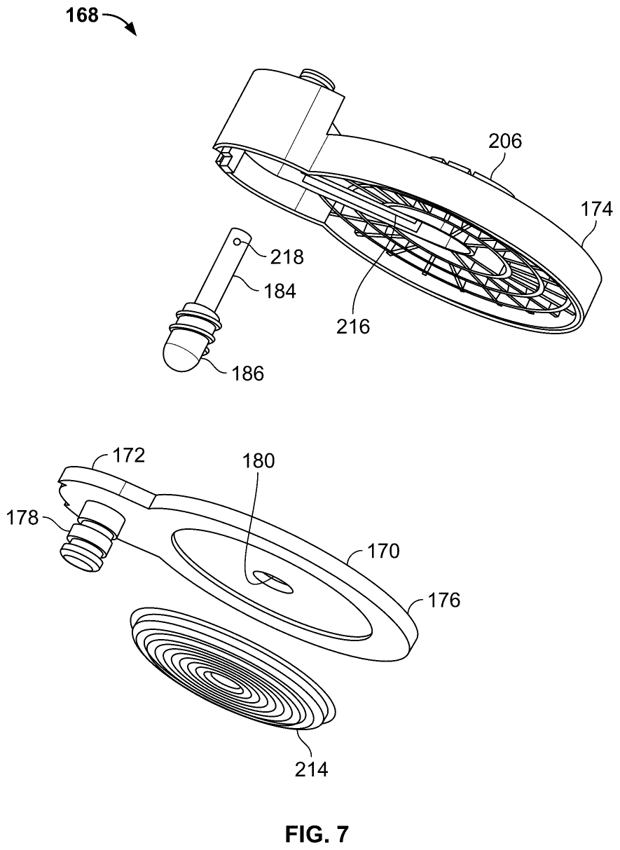

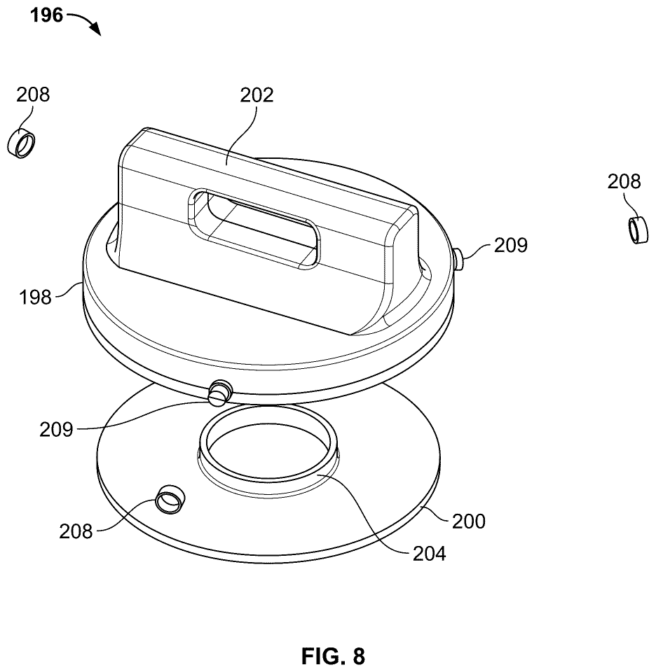

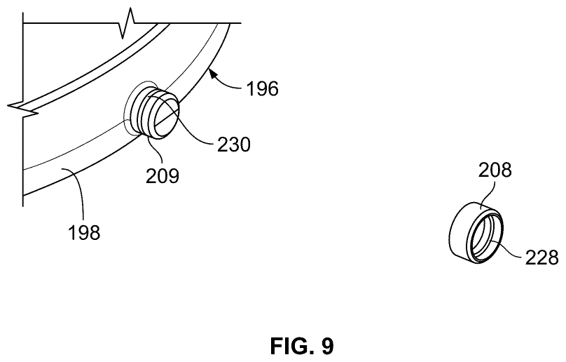

FIGS. 1 through 11 show certain aspects of an embodiment of a water treatment device 100 consistent with the present disclosure. For convenience, the device 100 is discussed herein in relation to use in a commercial or residential swimming pool for chlorination of pool water thereof. Specifically, the device 100 is configured to store tablets of a chemical material that includes cal hypo, and promote contact between the pool water and the chemical material such that the chemical material dissolves in the pool water to produce a chemical solution. In this example, the device 100 is configured to be installed in-line with a return line of the pool for mixing the chemical solution with the pool water. However, as noted previously, the device 100 and related systems are not limited to any particular application, any particular chemical materials or forms of chemical materials, or any particular installation. In addition, the device 100 and certain components thereof will be referred to herein as having upper and lower ends corresponding to the orientation of the device 100 as represented in FIG. 1. However, such terms are used merely to promote case of the following description and are not intended to limit the structure or installation of the device 100.

Referring initially to FIGS. 1-4, the device 100 includes a housing 110, an upper flange 114 fixed to an upper end of the housing 110, a lid assembly 120 releasably coupled to the upper flange 114, and a tee fitting 112 fixed to a lower end of the housing 110. The tee fitting 112 is configured to be coupled in-line with the return line (not shown) of the pool and to have the pool water flow therethrough. Typically, the pool water is drawn from the pool with a pump, forced through a filter and, optionally, various other pool system components (e.g., a water heating device), and then returned to the pool via the return line. The tee fitting 112 is configured to receive a volume of the pool water from the return line, provide the volume of the pool water to the housing 110 for production of the chemical solution, and then provide the chemical solution from the housing 110 to the return line. Flow of the pool water through the tee fitting 112 is represented with arrows in FIGS. 1-4.

The tee fitting 112 may be coupled to the return line by various connection systems such as but not limited to flange/fastener connections, threaded connections, welded connections, soldered connections, compression fitting connections, mechanical connections, crimped connections, and sleeve connections. In the example of FIGS. 1-4, the tee fitting 112 is configured to couple to the return line with compression fitting connections 118 that each include a rotatable nut (not shown) configured to releasably couple with threads 122 at corresponding ends of the compression fitting connections 118. In various embodiments, the tee fitting 112 may be configured to replace existing devices, such as saltwater chlorine generators. In other examples, the tee fitting 112 may include fitting connections 118 that include internal threads configured to couple with, for example, socket fittings or barb fittings (e.g., for connection to a hose). The tee fitting 112 includes an optional drain port 123 configured to provide an outlet for draining the pool water and/or chemical solution from the tee fitting 112 and/or the housing 110. In this example, the drain port 123 is releasably sealed with a drain port plug 124.

In various embodiments, the device 100 includes a support member 136 configured to receive the tee fitting 112 and support the tee fitting 112 and the housing 110. In some embodiments, the support member 136 may include legs configured to rest on a surface, such as the ground, a concrete pad, or another structure. In alternative embodiments, the support member 136 may be omitted and the device 100 may be supported, for example, by the return line of the pool.

The housing 110 includes an intake channel 130 and a chamber 128 fluidically separated by an interior wall 156 of the housing 110. During operation, the pool water is directed from the tee fitting 112, through the intake channel 130, through the lid assembly 120, through the chamber 128, and then back into the tee fitting 112. An intake channel inlet 135 at a lower end of the intake channel 130 is configured to provide fluidic access from the tee fitting 112 and the intake channel 130. In various embodiments, the intake channel inlet 135 has an angle, relative to the flow of fluid through the tee fitting 112, of about 60 to 80 degrees, such as about 65 to 75 degrees, such as about 70 degrees. A contoured or curved chamber base 132 at the lower end of the chamber 128 includes a chamber outlet 134 configured to provide fluidic access from the chamber 128 to the tee fitting 112.

Uppermost edges of the housing 110 and uppermost edges of the interior wall 156, in combination, define upper openings to the intake channel 130 and the chamber 128 which are fluidically coupled by the lid assembly 120, as discussed in more detail below.

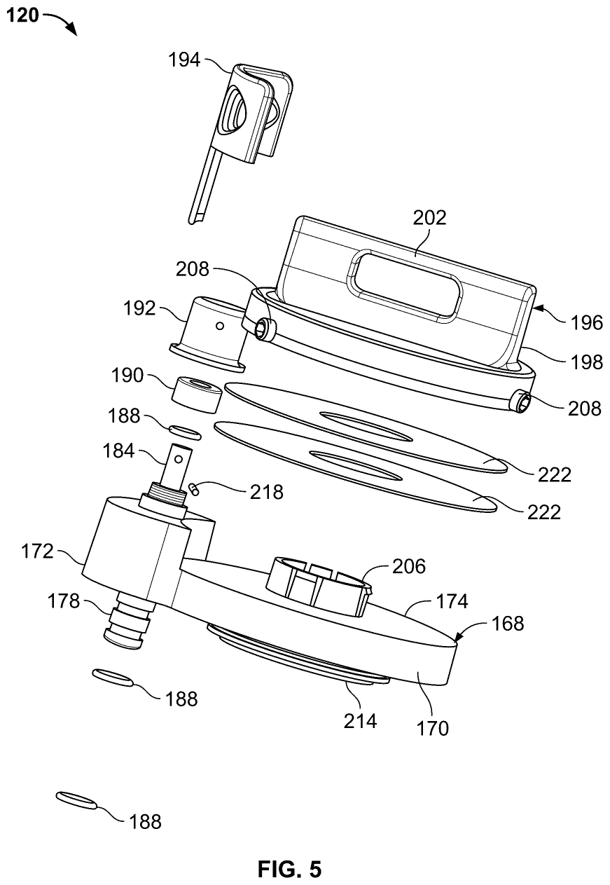

Referring to FIGS. 5-9, and with continued reference to FIGS. 1-4, the lid assembly 120 includes a top cap 168 that, in this example, includes a circular-shaped chamber portion 170 configured to cover the chamber opening 126 of the chamber 128 and a channel portion 172 extending therefrom configured to cover the upper opening of the of the intake channel 130. The top cap 168 includes an upper portion 174 and a lower portion 176. Interior surfaces of the upper portion 174 and the lower portion 176 in combination define a cavity therebetween. A top cap inlet 178 is configured to provide fluidic access from the intake channel 130 to the cavity of the top cap 168, and a top cap outlet 180 is configured to provide fluidic access from the cavity of the top cap 168 to the chamber 128. In the embodiment of the figures, the upper portion 174 of the top cap 168 includes a channel member 216 configured to direct the pool water through the cavity of the top cap 168 towards the top cap outlet 180.

Pool water flow into the top cap inlet 178 may be controlled with a valve. In this example, the valve includes a valve stem 184 with a valve plunger 186 on a lower end thereof, a valve cap 190 on an upper end thereof, and a valve knob 192 adjacent to the upper end of the valve stem 184 and coupled thereto, for example, with a pin 218. The valve knob 192 may be rotated to transition the valve stem 184 longitudinally within the top cap 168. When fully descended, the valve plunger 186 covers the top cap inlet 178 thereby impeding fluid flow into the top cap 168. As the valve stem 184 is caused to ascend, the top cap inlet 178 is uncovered and fluid is able to pass therethrough. In some examples, the top cap 168 and/or other surfaces of the lid assembly 120 may include markings adjacent to the valve knob 192 indicative of various flow rates to promote case of use. O-rings 188 may be provided to reduce the likelihood of leakage. The valve stem 184 may include threads configured to threadedly mate with corresponding threads within the upper portion 174. A t-handle 194 is coupled to the top cap 168 adjacent to the valve knob 192 that may be used as a handhold while inserting and/or removing the lid 120 from the housing 110, and/or inserting and/or removing the housing 110 from the support member 136. In addition, the t-handle 194 provides protection to the valve knob 192.

The top cap 168 may be secured with a lock plate 196. The lock plate 196 includes an upper portion 198 and a lower portion 200. The upper portion 198 may include a handle 202 configured to be gripped by a user. The lower portion 200 includes a central opening that defines a receiving member 204 configured to receive a connecting member 206 on an upper end of the top cap 168 and thereby rotatably coupled the lock plate 196 to the top cap 168. In various examples, the upper portion 198 and the lower portion 200 may be secured to each other with an adhesive material. In various examples, the receiving member 204 and the connecting member 206 may couple in a snap-fit manner.

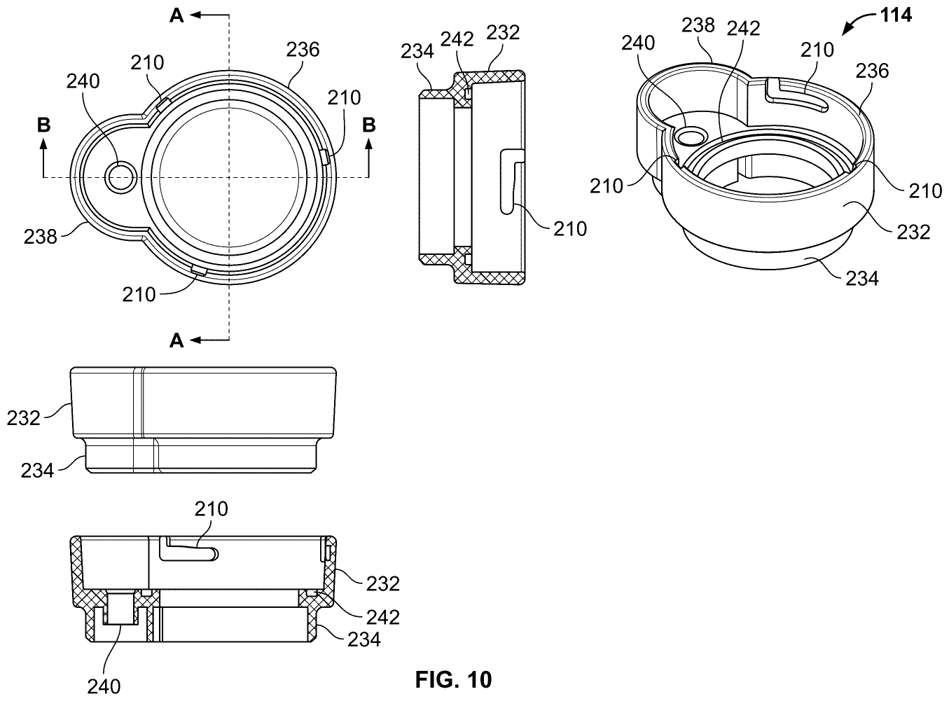

Once the lock plate 196 is coupled to the top cap 168, the lock plate 196 is configured to rotate relative to the top cap 168 by, for example, turning the handle 202. Optionally, one or more lubricating disks 222 may be located between the top cap 168 and the lock plate 196 to promote case of rotation. Rolling members 208 are located at spaced apart locations on an exterior of the lock plate 196 and rotatably coupled thereto on shafts 209. In certain embodiments, the rolling members 208 include inner ribs 228 configured to be received within channels 230 on exterior surfaces of the shafts 209 to promote retention of the rolling members 208 on the shafts 209. The lock plate 196 is configured to be located in the upper flange 114 such that the rolling members 208 are located with one or more lock channels 210 of the upper flange 114 (FIG. 10). In some examples, the configuration of the lubricating disks 222 and/or the rolling members 208 may allow for the lock plate 196 to be rotated about a quarter turn (relative to the full circumference of the top cap 168) to lock the top cap 168.

Referring to FIG. 10, the upper flange 114 includes a body having an upper portion 232 configured to mate with the lid assembly 120, and a lower portion 234 configured to mate with the housing 110. The body includes a chamber portion 236 shaped to cover the chamber 128 of the housing 110 and an intake channel portion 238 configured to cover the intake channel 130. An intake hole 240 is provided to receive and/or be fluidically connected with the top cap inlet 178. The upper flange 114 may include the scaling member 212 (e.g., O-ring) located in a sealing member recess 242 to promote a fluid-tight seal between the top cap 168 and the upper flange 114.

The lock channel(s) 210 are configured such that rotation of the lock plate 196, and thus movement of the rolling members 208 with the lock channel(s) 210, causes the lock plate 196 to transition downward toward the top cap 168. In this manner, rotation of the lock plate 196 applies a force against the top cap 168 in a direction toward the housing 110 to seal the chamber 128. In various embodiments, sealing of the housing 110 with the lock plate 196 provides an air-tight seal to the chamber 128. In various embodiments, once the lid assembly 120 has been secured to the housing 110 with the upper flange 114 therebetween, the chamber 128 includes an air-pocket. Such embodiments may ensure that that the tablets 220 remain dry while the pump is not in use, and ensures that the pool water is showered onto the tablets 220 but that the tablets 220 are not submerged in the pool water while the pump is operating to flow the pool water through the device 100. In various embodiments, some or all of the air within the chamber 128 may be displaced by pool water during operation of the device 100. In such embodiments, the device 100 may optionally include a check valve 226 configured to replace the displaced air as the pool water drains upon ceasing the pump. The check valve 226 may be any type of check valve such as a check ball valve or a check hose barb valve. In some embodiments, the check value 226 may be located on the device 100. In some embodiments, the check valve 226 may be located on the return line of the pool adjacent to the device 100.

In various embodiments, a chamber outlet member 158 is located within the chamber outlet 134. In some embodiments, the chamber outlet member 158 may be removably inserted into the chamber outlet 134. The chamber outlet member 158 extends above a lowermost interior surface of the chamber 128 and includes a flange at an upper end thereof that flares radially outward. A channel is provided through the chamber outlet member 158 between an inlet 160 at the upper end thereof and an outlet 162 within the tee fitting 112. In this manner, the channel of the chamber outlet member 158 fluidically connects the chamber 128 to the tee fitting 112 such that fluids within the chamber 128 are required to pool in the chamber base 132 of the chamber 128 to a depth sufficient to reach the inlet 160 of the chamber outlet member 158. This arrangement may promote retention of relatively large undissolved tablet fragments within the chamber 128 until the fragments sufficiently dissolve. In some embodiments, the chamber outlet member 158 may include a lower end configured to partially block fluid flow through the tee fitting 112 at a location below the chamber outlet member 158. For example, in FIGS. 1-4 the chamber outlet member 158 includes a lower end having an upstream portion 164 configured to partially block fluid flow through the tee fitting 112 received upstream from the return line, and a downstream portion that includes an opening defining the outlet 162 of the chamber outlet member 158 that is configured to allow fluid to exit the chamber 128 and enter the downstream return line. In various embodiments, the upstream portion 164 may be configured to block a predetermined volume of the pool water flowing therethrough. In some embodiments, a percentage of the predetermined volume of the pool water allowed to flow past the upstream portion 164 may be configured to promote a low pressure differential within the chamber 128.

In various embodiments, a diffuser 214 may be located below the top cap 168. The diffuser 214 may include an array of holes configured to distribute the pool water received from the top cap 168 over the chamber opening 126. With this arrangement, the pool water is showered over the tablets 220 such that the pool water contacts a top surface of an uppermost tablet 220 of the tablets 220 and travels via gravity down sides of the tablets 220 to the chamber base 132 of the chamber 128.

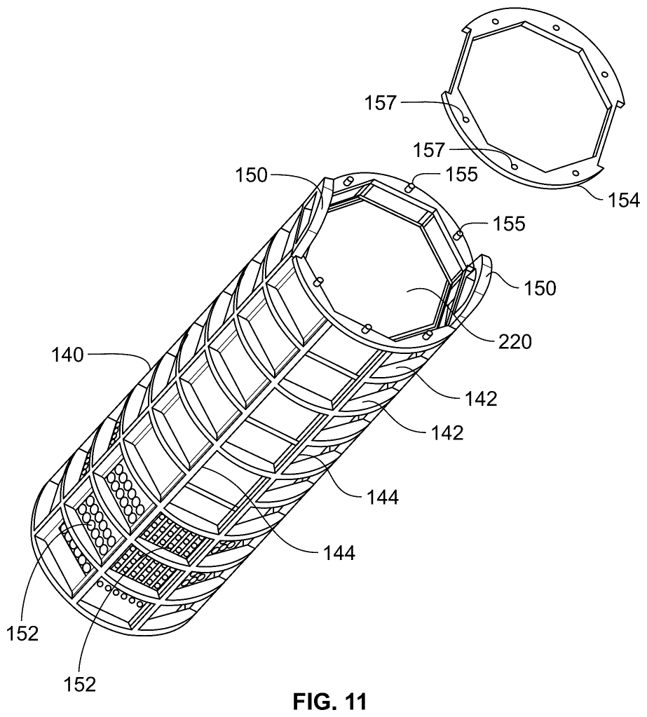

Referring to FIG. 11, with continued reference to FIGS. 1-10, the chamber 128 is configured to receive a removable cartridge 138 through the chamber opening 126 and store the cartridge 138 within the chamber 128. The cartridge 138 is configured to retain the chemical material therein in a manner that allows contact between the pool water and the chemical material within the chamber 128. In this example, the cartridge 138 includes a frame 140 that includes a plurality of tiered rings 142 spaced apart and fixed to a plurality of columns 144. The rings 142 and the columns 144, in combination, partially enclose a storage space within the frame 140 configured to store the chemical material. An uppermost of the rings 142 defines an opening at the upper end of the frame 140 that provides access to the storage space within the frame 140. A cartridge base 146 is located at an opposite, lower end of the frame 140 that is configured to support the chemical material stored within the storage space. The frame 140 includes handles 150 configured to provide handholds that promote case of removing the cartridge 138 from the chamber 128.

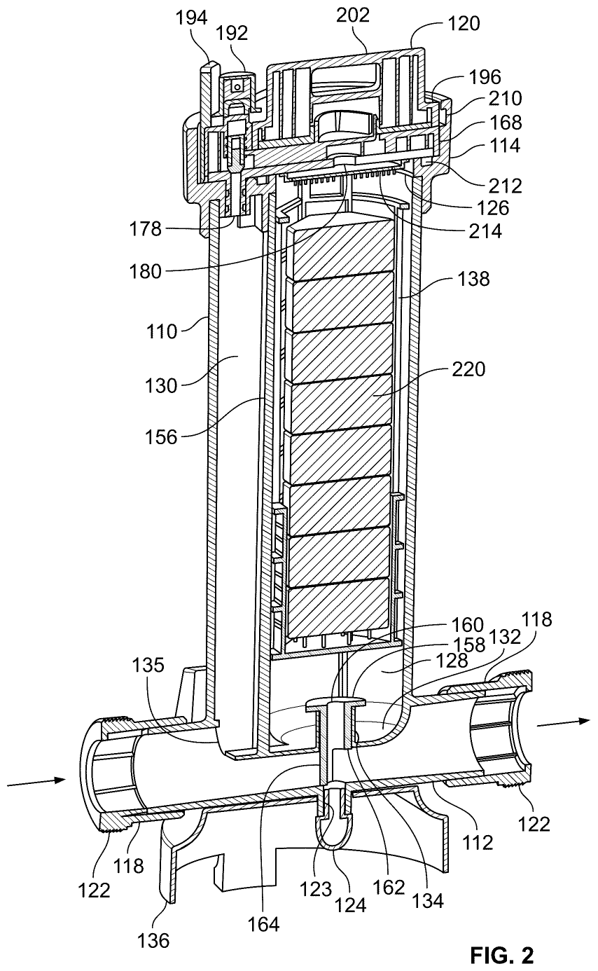

In this example, the frame 140 is configured to retain in the storage space thereof a stack of octangular prism-shaped tablets 220, as illustrated in FIGS. 2-4 and 11. As such, each of the rings 142 include radially inner edge that define an opening having an octagonal shape. Further, a mask member 154 may be coupled to an uppermost portion of the frame 140 having an opening configured to receive the octangular prism-shaped tablets 220. In certain embodiments, the mask member 154 may be coupled to the uppermost portion of the frame 140 by receiving pins 155 within holes 157. However, it should be understood that the shape of the tablets 220, and therefore the cross-sectional profiles of the rings 142, is nonlimiting and the tablets 220 and the rings 142 may have other shapes, such as but not limited to circular-shaped tablets, rectangular-shaped tablets, or briquettes of various shapes and sizes.

In various embodiments, the cartridge base 146 includes a plurality of pillars 148 extending from an upper face of the cartridge base 146 into the storage space. Distal ends of the pillars 148 are configured to contact a lowermost tablet 220 of the stack of tablets 220 such that the stack of the tablets 220 is supported thereon and such that a space or gap is provided between the upper face of the cartridge base 146 and a bottom of the stack of the tablets 220. Optionally, the pillars 148 may be tapered such that the diameters thereof decrease from adjacent to the cartridge base 146 to the distal ends thereof.

One or more of sections of the cartridge 138 defined by the rings 142 and the columns 144 may be covered with foraminate members 152 that each include an array of openings configured to allow passage of the chemical solution while simultaneously retaining partially dissolved particles of the tablets 220 that are larger in size than the openings. In various embodiments, the foraminate members 152 cover one or more lower tiers of the sections of the frame 140 and thereby define a catch cup. In various embodiments, portions or an entirety of one or more lower rows of the foraminate members 152 may be solid, that is, not include the array of openings such that the water collects at the cartridge base 146 prior to exiting the cartridge 138. In such embodiments, the water preferably does not collect to a depth sufficient to contact and submerge portions of the lowermost tablet 220 of the tablets 220, that is, the array of openings are provided at a location below the uppermost ends of the pillars 148.

During operation of the device 100 represented in FIGS. 1-11, the pool water is directed through the intake channel inlet 135, through the intake channel 130, through the top cap inlet 178, through the cavity of the top cap 168, through the top cap outlet 180, into the chamber 128, through the chamber outlet 134, and into the return line to be directed to the pool. While in the chamber 128, the pool water contacts the chemical material, dissolves the chemical material to produce the chemical solution, and exits the cartridge 138 on the above-described path to reenter the pool. Both the foraminate members 152 and the chamber outlet member 158 function to limit escape of undissolved fragments of the tablets 220 from the device 100. In various embodiments, the pool water does not entirely fill the chamber 128, and preferably does not submerge any of the tablets 220.

Exemplary but nonlimiting operational parameters of the device 100 may include fluid temperatures of between about 50 and 110° F. (10 and 43° C.), fluid flow rates of between about 0.2 and 5 gpm (0.8 and 18.9 lpm), preferably between 0.5 and 4.0 gpm (1.9 and 15.1 lpm), and fluid pressures between about 1 and 30 psi (about 7 and 207 kpa).

The device 100 and its components may include various materials including certain polymeric, metallic, ceramic, and/or composite materials. In an exemplary embodiment, the device 100 includes polyvinyl chloride (PVC).

The device 100 may be a component of a system for treating the pool water that includes, for example, one or more pumps configured to pull water from a source (e.g., the pool) for treatment of the water and return the water to the source after treatment thereof, various filtration devices configured to remove substances, particles, chemicals, etc. from the water (e.g., cartridge filters, sand filters, diatomaceous earth filters, etc.), various piping, fixtures, and valves, and/or various other components related to the transport, treatment, and/or conditioning of the water (e.g., water heating devices).

The device 100 provides for a method of treating water that includes, for example, receiving a flow of an aqueous fluid (e.g., the pool water), directing the flow of the aqueous fluid into the chamber 128 of the device 100 to contact surfaces of the solid chemical material within the cartridge 138, dissolve the solid chemical material within the device 100, and create the chemical solution of the aqueous fluid and the chemical material dissolved therein.

In various embodiments, the method includes directing the stream of the aqueous fluid to contact the upper surfaces of the solid chemical material (relative to a direction of gravity). The method may include providing gaps adjacent to surfaces of the solid chemical material, such as the upper surfaces, the lower surfaces, and sides thereof, sufficient to provide contact between the solid chemical material and air and to promote drainage of the aqueous fluid and the chemical solution produced therefrom. In various embodiments, the method includes receiving the flow of the aqueous fluid at a first location of a pipe having the aqueous fluid traveling therethrough and directing the chemical solution into the aqueous fluid of the pipe at a second location downstream from the first location.

The device 100 provides various benefits that may include reduced material handling due to the tablets 220 being located within the removable cartridge 138, and reduced maintenance due to fragments of the tablets 220 fully dissolving prior to exiting the device 100. In addition, while the lid assembly 120 is sealed to the housing 110, the chamber 128 is under an air-tight seal in which the tablets 220 remain substantially dry while the pool pump is not running and are contacted by a shower of water while the pool pump is running. In various embodiments, the chamber 128 is never entirely filled with the pool water, and the tablets 220 are never entirely submerged in the pool water. This is significantly different from many conventional devices which cause the pool water to enter from a bottom or side of the device and entirely submerge the tablets therein until fully dissolved. As such, the device 100 may promote a controlled and consistent dissolution pattern. Other notable features may include improved inlet flow even under low flow conditions due to the configuration of the intake channel inlet 135, even material dissolving due to the array of holes in the diffuser 214, and increased vacuum conditions on outlet flow due to the configuration of the chamber outlet member 158.

In this document, relational terms such as first and second, and the like may be used solely to distinguish one entity or action from another entity or action without necessarily requiring or implying any actual such relationship or order between such entities or actions. Numerical ordinals such as “first,” “second,” “third,” etc. simply denote different singles of a plurality and do not imply any order or sequence unless specifically defined by the claim language. The sequence of the text in any of the claims does not imply that process steps must be performed in a temporal or logical order according to such sequence unless it is specifically defined by the language of the claim. The process steps may be interchanged in any order without departing from the scope of the invention as long as such an interchange does not contradict the claim language and is not logically nonsensical.

Furthermore, depending on the context, words such as “connect” or “coupled to” used in describing a relationship between different elements do not imply that a direct physical connection must be made between these elements. For example, two elements may be connected to each other physically, electronically, logically, or in any other manner, through one or more additional elements.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention. Finally, while the appended claims recite certain aspects believed to be associated with the invention, they do not necessarily serve as limitations to the scope of the invention.

What is claimed is:

1. A device for preparing a chemical solution comprising:
a housing comprising a chamber, a chamber opening at a first end thereof configured to allow an aqueous fluid to flow into the chamber, and a chamber outlet at a second end thereof configured to allow the chemical solution to flow out of the chamber; and
a removable cartridge configured to retain therein a solid chemical material and to be received and releasably retained within the chamber, the removable cartridge having an opening at a first end thereof configured to receive the aqueous fluid from the chamber opening and at least one opening adjacent a second end thereof configured to allow the chemical solution to flow out of the cartridge toward the chamber outlet;
wherein the device is configured to direct flow of the aqueous fluid into the chamber to contact surfaces of the solid chemical material within the cartridge, dissolve the solid chemical material, and create the chemical solution of the aqueous fluid and the chemical material dissolved therein.

2. The device of claim 1, wherein the chamber of the housing is configured to retain therein a pocket of air, and wherein the removable cartridge includes a plurality of gaps in sides thereof configured to allow contact between the air and the solid chemical material.

3. The device of claim 2, wherein the housing includes an inlet configured to shower the flow of aqueous fluid over the solid chemical material within the cartridge such that the aqueous fluid travels through the cartridge via gravity toward the at least one opening adjacent the second end of the cartridge.

4. The device of claim 1, wherein a lowermost surface of the cartridge and sides of the cartridge adjacent to the lowermost surface are configured to receive the aqueous fluid and form a pool thereof, wherein the at least one opening adjacent the second end of the cartridge is configured to receive the aqueous fluid that overflows from the pool.

5. The device of claim 1, wherein the cartridge includes an array of pillars extending from the second end of the cartridge toward the first end of the cartridge, the array of pillars configured to support the solid chemical material thereon such that a gap is provided between surfaces of the solid chemical material and the second end of the cartridge.

6. The device of claim 1, further comprising a lid assembly configured to be releasably secured to the housing that is removable to provide access to the chamber for insertion and removal of the cartridge, the lid assembly having a cavity therein, an inlet configured to allow passage of the aqueous fluid into the cavity and an outlet configured to allow passage of the aqueous fluid from the cavity and into the chamber.

7. The device of claim 6, wherein the lid assembly includes a top cap that includes the cavity therein and a lock plate rotatably couple to the top cap and configured to be selectively rotated relative to the top cap to apply a force on the top cap and thereby secure the lid assembly to the housing.

8. The device of claim 6, wherein the lid assembly includes a valve configured to selectively seal the inlet thereof.

9. The device of claim 1, wherein the housing includes an intake channel that is separate from the chamber, the intake channel configured to receive the aqueous fluid adjacent a second end of the intake channel, direct the aqueous fluid through the intake channel towards a first end of the intake channel, and output the aqueous fluid at the first end of the intake channel to be directed to the chamber opening.

10. The device of claim 1, further comprising a fitting adjacent a second end of the housing that is configured to fluidically couple with pipes having the aqueous fluid flowing therethrough, wherein the fitting is configured to allow flow of the aqueous fluid from the pipes into the housing and allow flow of the chemical solution from the housing into the pipes.

11. The device of claim 1, wherein the device is configured to provide the chemical solution from the chamber outlet to a return line of a pool.

12. The device of claim 1, wherein the second end of the chamber includes a contoured shape configured to produce a venturi effect such that a velocity of the chemical solution is increased as the chemical solution passes through the chamber outlet.

13. A system for preparing a chemical solution comprising:
a chemical feeder comprising:
a housing comprising a chamber, a chamber opening at a first end thereof configured to allow an aqueous fluid to flow into the chamber, and a chamber outlet at a second end thereof configured to allow the chemical solution to flow out of the chamber; and
a removable cartridge configured to retain therein a solid chemical material and to be received and releasably retained within the chamber, the removable cartridge having an opening at a first end thereof configured to receive the aqueous fluid from the chamber opening and at least one opening adjacent a second end thereof configured to allow the chemical solution to flow out of the cartridge toward the chamber outlet;
wherein the chemical feeder is configured to direct flow of the aqueous fluid into the chamber to contact surfaces of the solid chemical material within the cartridge, dissolve the solid chemical material, and create the chemical solution of the aqueous fluid and the chemical material dissolved therein.

14. The system of claim 13, wherein the chamber of the housing is configured to retain therein a pocket of air, wherein the removable cartridge includes a plurality of gaps in sides thereof configured to allow contact between the air and the solid chemical material, wherein the housing includes an inlet configured to shower the flow of aqueous fluid over the solid chemical material within the cartridge such that the aqueous fluid travels through the cartridge via gravity toward the at least one opening adjacent the second end of the cartridge, wherein the cartridge includes an array of pillars extending from the second end of the cartridge toward the first end of the cartridge, the array of pillars configured to support the solid chemical material thereon such that a gap is provided between surfaces of the solid chemical material and the second end of the cartridge.

15. The system of claim 13, wherein the chemical feeder includes a lid assembly configured to be releasably secured to the housing that is removable to provide access to the chamber for insertion and removal of the cartridge, the lid assembly having a cavity, an inlet configured to allow passage of the aqueous fluid into the cavity and an outlet configured to allow passage of the aqueous fluid from the cavity and into the chamber, wherein the lid assembly includes a valve configured to selectively seal the inlet of the lid assembly.

16. The system of claim 15, wherein the lid assembly includes a top cap that includes the cavity therein and a lock plate rotatably couple to the top cap and configured to be selectively rotated relative to the top cap to apply a force on the top cap and thereby secure the lid assembly to the housing.

17. The system of claim 13, wherein the housing of the chemical feeder includes an intake channel that is separate from the chamber, the intake channel configured to receive the aqueous fluid adjacent a second end of the intake channel, direct the aqueous fluid through the intake channel towards a first end of the intake channel, and output the aqueous fluid at the first end of the intake channel to be directed to the chamber opening.

18. The system of claim 13, wherein the chemical feeder includes a fitting adjacent a second end of the housing that is configured to fluidically couple with pipes having the aqueous fluid flowing therethrough, wherein the fitting is configured to allow flow of the aqueous fluid from the pipes into the housing and allow flow of the chemical solution from the housing into the pipes.

19. A device comprising:
a housing having a chamber therein, an opening configured to provide access to the chamber, and two or more channels recessed in interior surfaces of the housing adjacent the opening;
a housing inlet configured to receive aqueous fluid and direct the aqueous fluid into the chamber;
a housing outlet configured to receive the aqueous fluid from the chamber and direct the aqueous fluid therefrom; and
a lid assembly configured to releasably cover and seal the opening of the housing, the lid assembly including a first member configured to cover the opening of the housing and a second member rotatably coupled to the first member, wherein the second member includes two or more rolling members configured to be received within the two or more channels of the housing, wherein the second member is configured to be selectively rotated relative to the first member to apply a force on the first member and thereby seal the opening, wherein rotation of the second member causes the two or more rolling members to travel within the two or more channels such that the second member moves toward the first member, wherein the two or more channels include features configured to retain the two or more rolling members in position once the second member is applying the force on the first member.

20. The device of claim 19, wherein the first member includes a cavity, a lid inlet configured to receive the aqueous fluid from the housing inlet and allow passage of the aqueous fluid into the cavity and a lid outlet configured to receive the aqueous fluid from the cavity and allow passage of the aqueous fluid into the housing outlet, wherein the lid assembly includes a valve configured to selectively seal the lid inlet of the lid assembly.
